(19) United States
(12) Patent Application Publication
(10) Pub. No.: US 2002/0189323 A1
(43) Pub. Date: Dec. 19, 2002

(54) Method and apparatus for measuring a fluid characteristic

(76) Inventor: Edward E. Francisco Jr., Paradise Valley, AZ (US)

Correspondence Address: CHRISTIE, PARKER & HALE, LLP, 350 WEST COLORADO BOULEVARD, SUITE 500, PASADENA, CA, 91105, US

(21) Appl. No.: 09/930,636

(22) Filed: Aug. 15, 2001

Related U.S. Application Data
(60) Provisional application No. 60/298,576, filed on Jun. 14, 2001.

(51) Int. Cl. G01N 9/00

(52) U.S. Cl. 73/32 R

(57) ABSTRACT

A tube through which fluid flows is installed in a fluid system. A piezoelectric driver is mounted on the exterior of the tube. A piezoelectric sensor is also mounted on the exterior of the tube. A feedback loop from the sensor to the driver is adapted to cause vibrations in the tube at its resonant frequency or a harmonic thereof. One or more strain gauges mounted on the exterior wall of the tube sense the strain exerted on the exterior wall by the pressure of the fluid flowing through the tube. A temperature sensor mounted on the exterior wall of the tube senses temperature. A microprocessor determines the density of the fluid flowing through the tube responsive to the piezoelectric sensor, temperature sensor and the one or more strain gauges. The one or more strain gauges comprise a bridge circuit. Strain gauges comprise two arms of the bridge circuit and temperature dependent resistors comprise the other two arms of the bridge. The output from the one or more strain gauges is used to correct the frequency reading given by the piezoelectric sensor.

### RELATED APPLICATION

This application claims priority of U.S. provisional Application No. 60/298,576, filed Jun. 14, 2001, the disclosure of which is incorporated fully herein by reference. This

### BACKGROUND OF THE INVENTION

This invention relates to measurement of a fluid characteristic and, more particularly, to a method and apparatus that compensates for pressure changes in the fluid being measured.

A known technique for measuring fluid characteristics such as fluid density and fluid flow rate is to pass the fluid through a tube and to set up vibrations in the tube. The resonant frequency of the tube depends upon the inherent characteristics of the tube and the fluid passing through the tube. For example, as the density of the fluid increases the effective mass of the tube also increases and the resonant frequency of the tube decreases. The stresses on the tube also affect the resonant frequency. These stresses are caused by various factors, the hydrostatic pressure within or on the measurement tube, its temperature, and the whole densimeter's mounting hardware. For example, as the fluid pressure increases, the spring constant of the tube increases and the resonant frequency of the tube increases. In order to make the resonant frequency of the tube representative of the fluid density independent of pressure, the fluid pressure must be measured.

Typically, the fluid pressure is measured by inserting a pressure transducer inside the tube in contact with the fluid. As a result, the pressure transducer is exposed to the fluid, which can be intolerable if the fluid has destructive characteristics, i.e., if the fluid is corrosive or abrasive. Furthermore, in order to gain access to the pressure transducer for inspection, repair or replacement, the fluid system must be dismantled.

### SUMMARY OF THE INVENTION

According to the invention, a tube is installed in a fluid system to ascertain changes in a characteristic of the fluid contained in the tube, such as resonant frequency. The fluid pressure in the tube is sensed by one or more strain gauges mounted on the exterior wall of the tube. The strain gauges measure the strain in the tube, which is proportional to the pressure exerted by the fluid on the tube. The measured strain is used to compensate for pressure induced changes in the tube's characteristics.

In one embodiment which senses fluid density, a tube through which fluid flows is installed in a fluid system. A piezoelectric or magnetic driver is mounted on the exterior of the tube. A piezoelectric or magnetic sensor is also mounted on the exterior of the tube. A feedback loop from the sensor to the driver is adapted to cause vibrations in the tube at its resonant frequency or a harmonic thereof. One or more strain gauges mounted on the exterior wall of the tube senses the strain exerted on the exterior wall by the pressure of the fluid flowing through the tube. A microprocessor determines the density of the fluid flowing through the tube responsive to the tube's motion, temperature sensor, and the one or more strain gauges.

In its preferred embodiment, the one or more strain gauges comprise a bridge circuit. Strain gauges comprise two arms of the bridge circuit and temperature dependent resistors comprise the other two arms of the bridge circuit. The output from the one or more strain gauges is used to correct the frequency reading given by the piezoelectric sensor.

### BRIEF DESCRIPTION OF THE DRAWINGS

The features of specific embodiments of the best mode contemplated of carrying out the invention are illustrated in the drawings, in which:

FIG. 1 is a schematic block diagram of a vibrating tube densimeter illustrating principles of the invention;

FIG. 2 is a diagram of a vibrating tube having temperature and pressure sensing elements mounted on the exterior wall of the tube; and

FIG. 3 is an electrical schematic diagram of the temperature and pressure sensing elements of FIG. 2 connected in a bridge circuit.

### DETAILED DESCRIPTION OF THE INVENTION

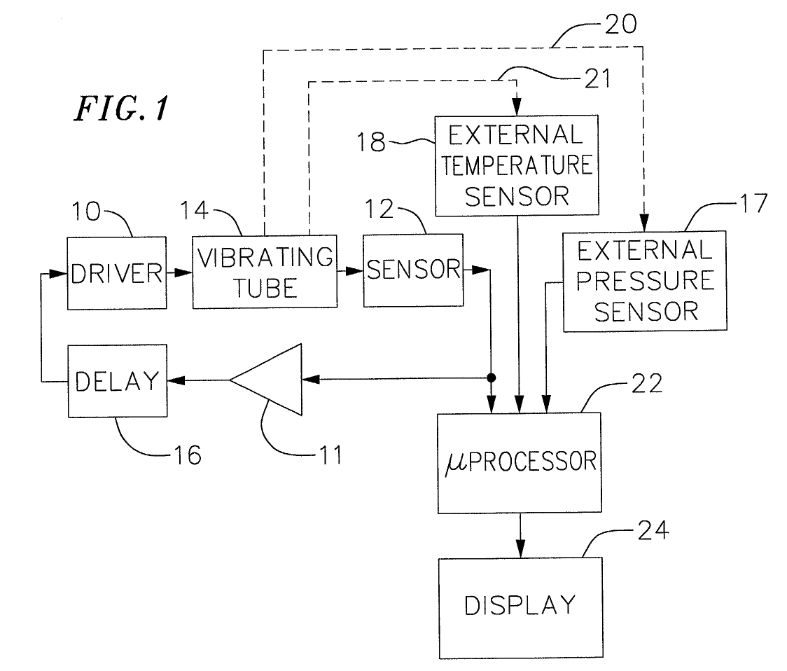

In FIG. 1 a driver 10 and a sensor 12 are mounted on the exterior wall of a vibrating tube 14. Tube 14 is installed in a flowing fluid system (not shown) such as a chemical plant, a refinery, or a food processing plant. Tube 14 could be directly installed in the fluid system so all the fluid flows through tube 14 or could be installed as a probe in the manner illustrated in U.S. Pat. No. 5,974,858, which issued on Nov. 2, 1999, the disclosure of which is incorporated herein by reference. The output of sensor 12 is coupled by an amplifier 11 to driver 10 in a feedback loop that also includes a delay 16. Typically, driver 10 and sensor 12 are piezoelectric or magnetic devices. By virtue of the feedback loop from sensor 12 to driver 10, tube 14 vibrates at its resonant frequency or a harmonic thereof. Amplifier 11 provides the power for these vibrations. The phase shift from the output of sensor 12 to the input of driver 10 depends in part on the relative circumferential positioning of driver 10 and sensor 12. The described components are analogous to an electrical oscillator; the mass and spring constant of tube 14 are analogous to the tank circuit of the oscillator. Delay 16 is designed to create regenerative feedback. Delay 16 represents delay caused by the relative positioning of driver 10 and sensor 12 around the circumference of tube 14 and/or an electrical delay in the feedback loop. As is known in the art, the resonant frequency of tube 14 depends upon the tube's mass, spring constant, the density of the fluid traveling through tube 14, the temperature of the fluid inside the tube 14, and is also affected by the fluid pressure inside tube 14. A temperature sensor outside tube 14 senses the temperature of the fluid. Sensor 18 could be an off the shelf resistive temperature device (RTD) that changes resistance in a linear relationship to temperature. In the prior art, to compensate for fluid pressure an internal pressure sensor has been mounted inside the tube in contact with the fluid. According to the invention, however, an external pressure sensor 17 is mounted on the outside wall of tube 14. As represented by a dashed line 20, pressure sensor 17 responds to the pressure of the fluid within tube 14. As represented by a dashed line 21, an external temperature sensor 18 responds to the temperature of tube 14, which is representative of the fluid temperature inside tube 14. The output of sensor 12 which represents the resonant frequency of tube 14 or a harmonic thereof, including the fluid contained therein, the output of external pressure sensor 17, and the output of external temperature sensor 18 are coupled to the inputs of a microprocessor 22, which is programed to calculate the density of the fluid contained within tube 14. The calculated density can be read from a display 24.

Alternatively, the invention could be used to measure the density of a static fluid, i.e., a non-flowing fluid or the flow rate of fluid in a fluid system, as in a Coriolis meter.

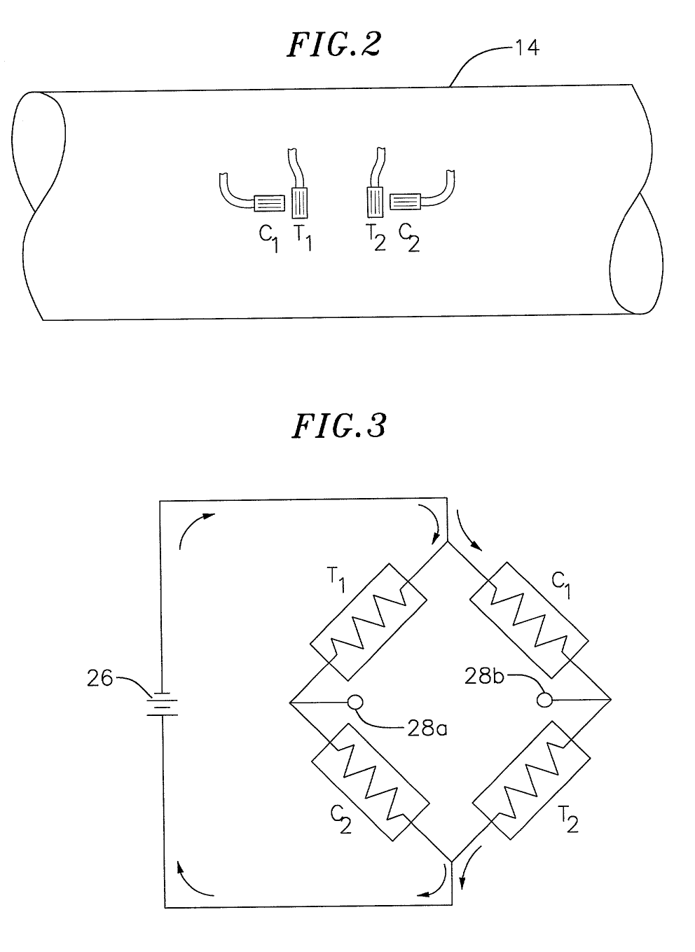

FIG. 2 illustrates part of the exterior wall of vibrating tube 14. Axially arranged strain gauges C1 and C2 are mounted on the exterior sidewall of tube 14. Circumferentially arranged strain gauges T₁ and T₂ are mounted on the exterior sidewall of tube 14 orthogonally to strain gauges C₁ and C₂. Strain gauges C1, C2, T1 and T2 could be of the metal foil type.

As shown in FIG. 3, strain gauges T₁ and T₂ and strain gauges C₁ and C₂ are electrically connected in a bridge circuit to generate a signal representative of fluid pressure within tube 14. Strain gauges T₁ and T₂ and strain gauges C₁ and C₂ comprise the arms of the bridge circuit. One terminal of a direct current bias source 26 is connected to the junction of strain gauge T₁ and strain gauges C₁. The other terminal of bias source 26 is connected to the junction of strain gauge C₂ and strain gauge T₂. The junction of strain gauge T₁ and resistor C₂ comprises one output 28a terminal of the bridge circuit. The junction of strain gauge T₂ and resistor C₁ comprises the other output 28b of the bridge circuit. Temperature does not affect the output of the bridge because the temperature dependent changes of the strain gauges cancel each other. The outputs of the bridge circuit are coupled to microprocessor 22 to compensate for fluid pressure changes.

One of a number of suitable algorithms is selected to calculate a pressure compensated density value. The presently preferred algorithm is the following:

Dpt=DT+(DT×Kp1×P)+(Kp2×P)+Kp3×P²

In this algorithm, Dpt represents the calculated density, DT represents density corrected for frequency and temperature, P represents the pressure measured by the bridge circuit of FIG. 3, P² represents the measured pressure squared, and Kp1, Kp2, and Kp3 are constants derived by calibration. The constants are determined by weighing a reference fluid over a range of known temperatures and pressures that will be encountered in the course of the measurements. Typical reference fluids for this purpose are propylene glycol, ethylene glycol, propane, or another fluid that responds linearly to temperature and pressure. The pressure is held constant while the temperature is varied and the measured resonant frequency is recorded. Then, the temperature is held constant while the pressure is varied and the measured resonant frequency is recorded. The constants are selected so the calculated density, Dpt, equals the known fluid density at each pressure and temperature.

The described embodiment of the invention is only considered to be preferred and illustrative of the inventive concept; the scope of the invention is not to be restricted to such embodiment. Various and numerous other arrangements may be devised by one skilled in the art without departing from the spirit and scope of this invention. For example, instead of a bridge composed of strain gauges, a single strain gauge could be used, but this produces half the output signal amplitude of a full bridge, and is very temperature sensitive.

What is claimed is:

1. Apparatus for measuring a characteristic of a fluid comprising:
a hollow tube that contains the fluid;
means for inducing the tube to vibrate at its resonant frequency or a harmonic thereof;
means for sensing the frequency of the vibrations;
means for sensing the strain in the wall of the tube; and
means responsive to the frequency sensing means and the strain sensing means for calculating the fluid characteristic.

2. The apparatus of claim 1, in which the strain sensing means is located on the exterior wall of the tube out of contact with the fluid.

3. The apparatus of claim 1, in which the tube is straight.

4. The apparatus of claim 1, in which the inducing means causes the tube to vibrate axially.

5. The apparatus of claim 1, in which the inducing means causes the tube to vibrate radially.

6. The apparatus of claim 1, in which the inducing means comprises a piezoelectric or magnetic driver mounted on the tube, a piezoelectric or magnetic sensor mounted on the tube, a feedback loop connecting the sensor to the driver; and a delay in the feedback loop designed so the driver is in phase with the sensor.

7. The apparatus of claim 1, in which the frequency sensing means comprises a piezoelectric or magnetic sensor.

8. The apparatus of claim 1, in which the strain sensing means comprises a bridge circuit having first and second arms connected in series, third and fourth arms connected in series, a bias source connected between the junction of the first and third arms and the junction of the second and fourth arms, a first output terminal at the junction of the first and second arms, and a second output terminal at the junction of the third and fourth arms, the first and third arms comprising strain dependent resistors, and the second and fourth arms comprising temperature dependent resistors.

9. The apparatus of claim 1, in which the tube is installed in a flowing fluid system so the flowing fluid passes through the tube.

10. The apparatus of claim 8, in which the fluid characteristic is density and the calculating means calculates the density of the fluid.

11. The apparatus of claim 8, in which the fluid characteristic is flow rate and the calculating means calculates the flow rate of the fluid.

12. The apparatus of claim 1, additionally comprising means for displaying the calculated fluid characteristic.

13. The apparatus of claim 1, additionally comprising means for sensing the temperature of the fluid, the calculating means being partially responsive to the temperature sensing means to correct the calculated fluid characteristic for temperature changes.

14. The apparatus of claim 2, in which the inducing means comprises a piezoelectric driver mounted on the tube, a piezoelectric sensor mounted on the tube, a feedback loop connecting the sensor to the driver; and a delay in the feedback loop designed so the driver is in phase with the sensor.

15. The apparatus of claim 14, in which the frequency sensing means comprises a piezoelectric sensor.

16. The apparatus of claim 15, in which the strain sensing means comprises a bridge circuit having first and second arms connected in series, third and fourth arms connected in series, a bias source connected between the junction of the first and third arms and the junction of the second and fourth arms, a first output terminal at the junction of the first and second arms, and a second output terminal at the junction of the third and fourth arms, the first and third arms comprising strain dependent resistors, and the second and fourth arms comprising temperature dependent resistors.

17. The apparatus of claim 16, in which the tube is installed in a flowing fluid system so the flowing fluid passes through the tube.

18. The apparatus of claim 17, additionally comprising means for displaying the calculated fluid characteristic.

19. The apparatus of claim 18, in which the inducing means causes the tube to vibrate axially.

20. The apparatus of claim 18, in which the inducing means causes the tube to vibrate radially.

21. The apparatus of claim 19, in which the fluid characteristic is density and the calculating means calculates the density of the fluid.

22. The apparatus of claim 20, in which the fluid characteristic is density and the calculating means calculates the density of the fluid.

23. The apparatus of claim 19, in which the fluid characteristic is flow rate and the calculating means calculates the flow rate of the fluid.

24. The apparatus of claim 20, in which the fluid characteristic is flow rate and the calculating means calculates the flow rate of the fluid.

25. A densimeter comprising:
a tube through which fluid flows;
a piezoelectric driver mounted on the exterior of the tube;
a piezoelectric sensor mounted on the exterior of the tube;
a feedback loop from the sensor to the driver adapted to cause vibrations in the tube at its resonant frequency or a harmonic thereof;
one or more strain gauges mounted on the exterior wall of the tube to sense strain exerted on the exterior wall by the pressure of fluid flowing through the tube; and
a microprocessor for determining the density of the fluid flowing through the tube responsive to the piezoelectric sensor and the one or more strain gauges.

26. A method for determining the density of a fluid flowing through a fluid system, the method comprising the steps of:
installing a straight tube in the fluid system so fluid flowing through the system also flows through the tube;
setting up vibrations in the tube;
sensing the frequency of the vibrations;
sensing strain in the wall of the tube caused by the pressure of the fluid flowing through the tube; and
calculating the density of the fluid flowing through the tube from the sensed frequency and the sensed strain.
